(19) United States
(12) Patent Application Publication
(10) Pub. No.: US 2024/0205529 A1
(43) Pub. Date: Jun. 20, 2024

(54) CAMERA WITH SPEAKER BOX

(71) Applicant: Shenzhen Quanzhi Information Technology Co., Ltd., Shenzhen (CN)

(72) Inventors: Jingjing WANG, Shenzhen (CN); Yunping TIAN, Shenzhen (CN)

(21) Appl. No.: 18/223,351

(22) Filed: Jul. 18, 2023

(30) Foreign Application Priority Data
Dec. 14, 2022 (CN) 202223372006.0

(51) Int. Cl. H04N 23/57; H04N 23/51; H04N 23/90; H04R 1/02

(52) U.S. Cl. CPC H04N 23/57; H04N 23/51; H04N 23/90; H04R 1/028

(57) ABSTRACT

The present application relates to a technical field of audio-visual equipment, and in particular to a camera with a speaker box. The camera with a speaker box includes a speaker box body configured for generating audio and a camera module, the speaker box body includes a speaker housing and a speaker assembly mounted inside the speaker housing, the camera module is mounted on the speaker box body via a connection assembly, the camera module comprises a camera housing and a camera assembly mounted in the camera housing and configured to capture an image.

### CROSS-REFERENCE TO RELATED APPLICATION

The present application claims the priority to Chinese patent application No. 202223372006.0, filed on Dec. 14, 2022. The entirety of Chinese patent application No. 202223372006.0 is hereby incorporated by reference herein and made a part of this specification.

### BACKGROUND

The present application relates to a technical field of audio-visual equipment, and in particular to a camera with a speaker box.

At present, webcam is a new generation of product combining traditional camera and network video technology. Especially during meeting recording, the participants' on-site participation can be record and a meeting minute is formed for subsequent reference.

In related technologies, cameras generally only acquire images in the viewing range; however, images of the situations outside the viewing range cannot be captured. For example, when the spokesperson changes, the camera needs to receive instructions passively to target the spokesperson after change of spokesperson, so the original part of the spokesperson's speech after change of speaker box is not easily recorded.

In the related technologies mentioned above, it is difficult for the camera to completely capture images in all aspects when there are multiple spokespersons at the same time, or the conversation is short, or the speakers changes frequently.

### SUMMARY

A camera with a speaker box provided in the present application adopts the following technical solutions:
a camera with a speaker box, comprising:
a speaker box body, the speaker box body comprises a speaker housing and a speaker assembly mounted inside the speaker housing, and the speaker assembly is configured for generating audio; and
a camera module, mounted on the speaker box body via a connection assembly, the camera module comprises a camera housing and a camera assembly mounted in the camera housing and configured to capture an image.

In some embodiments of the present application, the camera assembly comprises at least two cameras with different directions of incoming light.

In some embodiments of the present application, the two cameras are arranged opposite to each other.

In some embodiments of the present application, an included angle between directions of incoming light of the two cameras is from 5 degrees to 150 degrees.

In some embodiments of the present application, the camera assembly comprises a wide-angle camera.

In some embodiments of the present application, the camera housing is configured to be any one selected from a group consisting of spherical, cylindrical or frustum.

In some embodiments of the present application, the camera housing comprises at least three vertical panels, the three vertical panels are enclosed to form a side panel, each of the three vertical panels is mounted with a camera.

In some embodiments of the present application, the camera housing comprises three vertical panels, and an included angle between directions of incoming light of two cameras of adjacent vertical panels is 120 degrees.

In some embodiments of the present application, the camera housing comprises a bottom panel and a side panel, and the bottom panel and the side panel are enclosed to form a cavity for accommodating the camera module.

In some embodiments of the present application, the camera housing is configured to be top opened.

In some embodiments of the present application, the side panel is covered with a top panel at a side away from the bottom panel.

In some embodiments of the present application, the connection assembly comprises a connecting rod, a first hole is formed in speaker housing for the connecting rod to pass through at the top of the speaker housing, a second hole is formed in the bottom panel for the connecting rod to pass through, the connecting rod is connected with two limit blocks, and one of the two limit blocks is configured to be stuck inside the speaker housing, and the other of the two limit blocks is configured to be stuck inside the camera housing.

In some embodiments of the present application, the connection assembly is a motor, the motor comprises an output shaft, a first hole is formed in speaker housing for the output shaft to pass through at the top of the speaker housing, a second hole is formed in the bottom panel for the output shaft to pass through.

In some embodiments of the present application, a body of the motor is mounted in the speaker housing, and the output shaft of the motor penetrates through the first hole and the second hole and is fixed to the camera housing, so that the output shaft of the motor moves synchronously with the camera housing.

In some embodiments of the present application, the body of the motor is mounted in the camera housing, and the output shaft of the motor penetrates through the second hole and the first hole and is fixed to the speaker housing, so that the body of the motor moves synchronously with the camera housing.

In some embodiments of the present application, the speaker housing and the camera housing contain a transparent housing.

In some embodiments of the present application, the speaker housing or the camera housing contains a transparent housing.

In some embodiments of the present application, the speaker assembly comprises a wireless communication module and a wire communication module.

In some embodiments of the present application, the connection assembly comprises a first drive source configured for driving the camera housing up and down, a second drive source configured for driving the camera housing to rotate around a vertical axis, and a third drive source configured for driving the camera housing to rotate around a horizontal axis.

In some embodiments of the present application, the connection assembly comprises a rotatable plate and a support plate rotatably connected with each other, the rotatable plate is located above the support plate, the first drive source is configured to drive the support plate up and down, the second drive source is provided on the support plate for driving the rotatable plate to rotate, the rotatable plate comprises a support strip hinged with the rotatable plate, and a third drive source is provided on the rotatable plate for driving the camera housing to rotate.

In summary, the present application is able to achieve at least one of the following beneficial technical effects:
1. the speaker box body and the camera assembly are integrated together in the present application to make the product more integrated, more functional and structurally compact;
2. multiple camera modules can set, and image data from different directions can be acquired, then multi-angle images and even panoramic images can be captured; and
3. the speaker housing and the camera housing are set to be transparent to allow easy observation of the internal structure of the product and the internal operating process under operating condition.

### BRIEF DESCRIPTION OF DRAWINGS

FIG. 1 is an overall structural schematic diagram in a first angle of view of the camera with a speaker box according to embodiments of the present application.

FIG. 2 is a cross-sectional diagram illustrating the structure of the motor of the present application in direction A in FIG. 3.

FIG. 3 is a top view of the camera housing in triangular prism shape as a whole according to embodiments of the present application.

FIG. 4 is a structural schematic diagram of a cylinder-shaped camera housing as a whole according to embodiments of the present application.

FIG. 5 is a structural schematic diagram of a sphere-shaped camera housing as a whole according to embodiments of the present application.

FIG. 6 is a structural schematic diagram of the camera module according to embodiments of the present application.

FIG. 7 is a structural schematic diagram of the camera module according to embodiments of the present application.

FIG. 8 is a structural schematic diagram of the speaker box body according to embodiments of the present application.

FIG. 9 is a connection diagram of modules within the speaker assembly according to embodiments of the present application.

FIG. 10 is a cross-sectional diagram illustrating the structure of the connecting rod of the present application in direction A of FIG. 3.

FIG. 11 is an overall structural schematic diagram in a second angle of view of the camera with a speaker box according to embodiments of the present application.

FIG. 12 is a cross-sectional diagram illustrating the structure of the connecting assembly according to embodiments of the present application.

FIG. 13 is an enlarged schematic diagram at A in FIG. 12.

### DETAILED DESCRIPTION

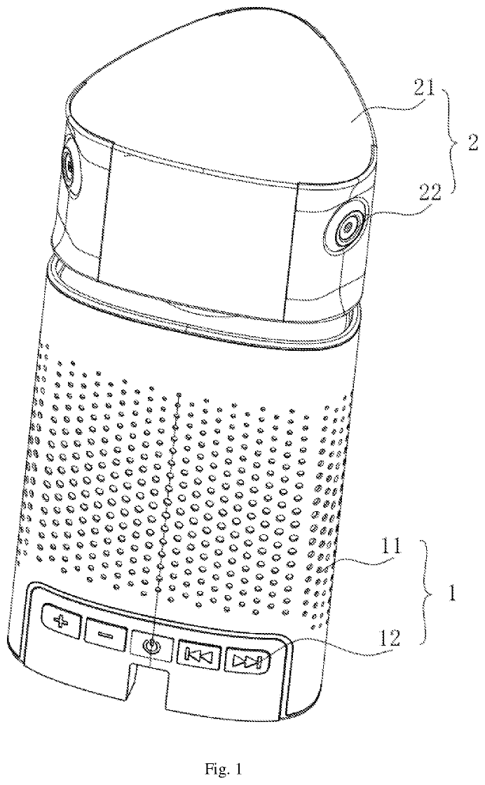

The technical solutions in the embodiments of the present application will be described clearly and completely below in combination with FIGS. 1-13 of the present application. It is clear that the embodiments described are only part of, but not all of, the embodiments of the present application.

An embodiment of the present application discloses a camera with a speaker box.

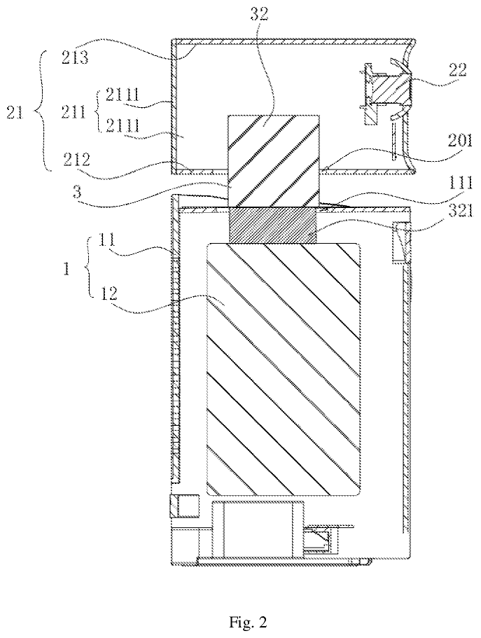

Referring to FIGS. 1 and 2, a camera with a speaker box includes a speaker box body 1 and a camera module 2, in which the camera module 2 is mounted on the speaker box body 1 via a connection assembly 3.

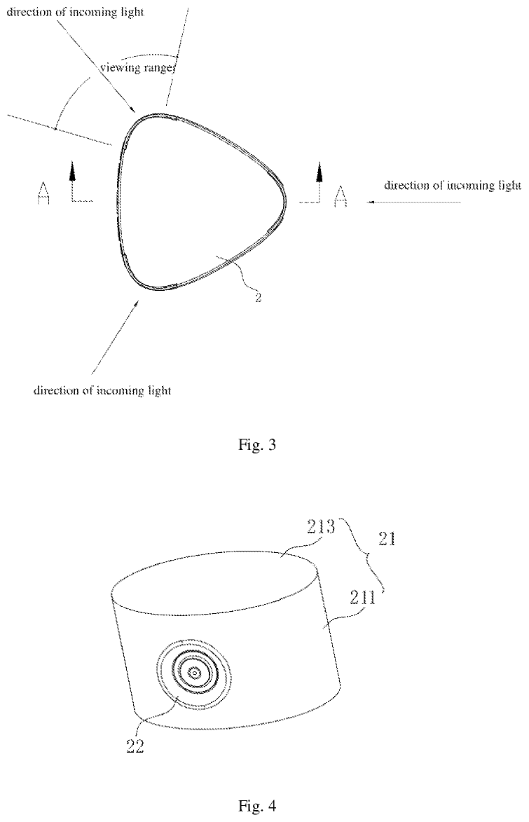

Referring to FIGS. 2 and 3, the camera module 2 includes a camera housing 21 and a camera assembly 22, in which the camera assembly 22 is mounted in the camera housing 21. The camera assembly 22 has basic functions such as video capture/transmission and static image capture, and can be used for meeting recording, real-time monitoring, remote education and meeting recording. The camera assembly 22 may include more than one wide-angle camera, or one or more cameras.

Referring to FIG. 2, the camera housing 21 further includes a bottom panel 212 and a side panel 211, and the bottom panel 212 and the side panel 211 are enclosed to form a cavity for accommodating the camera module 2. The camera housing 21 may be in a semi-enclosed state. The camera housing 21 may be configured to be top opened, so that the inner camera assembly 22 is exposed, which is convenient for development and debugging. The side panel 211 is in an enclosed state, and the side panel 211 may be visually present as a triangular, square, pentagonal, hexagonal, circular or other shapes from a top-down perspective. Further, the side panel 211 is covered with a top panel 213 at a side away from the bottom panel 212, such that the camera housing 21 is in an enclosed state, thereby reducing the dust accumulation inside the cavity.

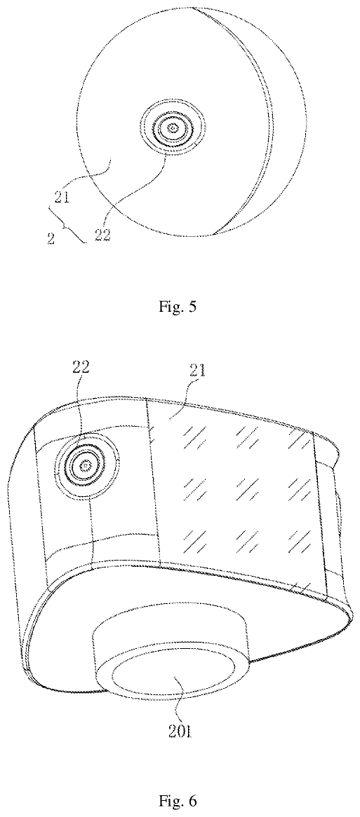

Referring to FIGS. 4 and 5, the shape of the bottom panel 212 described above matches the shape formed by the side panel 211. For example, when the side panels 211 are tubular, and the overall shape formed by the side panel 211 from a top-down perspective is circular, the corresponding bottom panel 212 and top panel 213 are circular, and the overall shape of the camera housing 21 is cylindrical. When the side panels 211 are configured in an enclosed spherical shape, the bottom panel 212 and the top panel 213 are spherical, thus the formed camera housing 21 is a spherical body. Further, for the overall aesthetics and ease of assembly, the bottom panel 212 and side panel 211 can be integrally formed, and the top panel 213 and side panel 211 can also be integrally formed. At least one camera mounting hole is formed in the side panel 211, and images showing outside the camera mounting hole can captured by the corresponding camera assembly 22. In another embodiments, the camera housing 21 may also be table-shaped, etc., enabling wider scene requirements.

Referring to FIG. 6, the above-mentioned camera housing 21 may either be partially or entirely transparent, and the transparent housing may be made of glass, PMMA (polymethyl methacrylate), etc., so that the operation state of the internal camera assembly 22 can be easily observed while the camera module 2 is in operation.

Referring to FIG. 3, in some embodiments, the camera assembly 22 includes a wide-angle camera, corresponding to which one camera mounting hole is formed on the side panel 211, and the main optical axis of the wide-angle camera is coaxially set with the camera mounting hole. Wide-angle camera has short focal length and large visual angle, and is able to shoot a wide range of scenes at close range with outstanding foreground. Wide-angle camera has a significantly larger field depth than standard lens and long-focus lens, and has a strong stereo perception. In meeting recording, the wide-angle camera has a visual angle of over 120 degrees, or even 180 degrees, and can obtain as larger viewing range as possible with simpler camera assembly 22, thus can capture a wider image of the meeting.

Referring to FIG. 6, in another embodiments, the camera assembly 22 may include at least two cameras with different directions of incoming light. Direction of incoming light refers to the direction in which light enters an optical system along the main optical axis of the optical system. In this embodiment, at least two cameras are included, which means that two, three or more optical systems are included. Since the directions of incoming light of any two cameras are inconsistent, the visual angle from which the image is acquired is inconsistent, and the range of view is inconsistent, then the viewing range for image acquisition can be increased. It should be noted that there is not always an overlap between images captured by two cameras. When there is a certain distance between spokespersons in a meeting, the position of the camera with a speaker box can be adjusted, and the camera can be focused as accurately to the spokesperson as possible, such that the images captured have wider field of view.

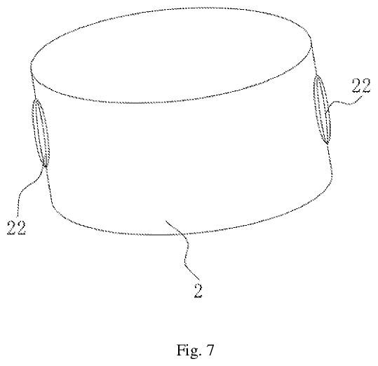

Referring to FIG. 7, in some embodiments, the two camera assemblies 22 may be arranged opposite to each other. Compared with condition of only one camera, this embodiment reduces the angle of rotation of the camera when the spokesperson speaking in a meeting. It should be noted that, an included angle between directions of incoming light of the two cameras includes but is not limited to 180 degrees. In another embodiments, the included angle between directions of incoming light of the two cameras is from 5 degrees to 150 degrees which can be selected according to actual conditions.

Referring to FIG. 3 and FIG. 6, the side panel 211 is visually present as a triangular from a top-down perspective, and is formed by three vertical panels 2111. The bottom panel 212 and the top panel 213 are also triangular, to achieve an enclosed state of the bottom panel 212, the top panel 213 and the side panel 211. A camera mounting hole is formed in each of the three vertical panel 2111, and each of the camera mounting holes corresponds to a wide-angle camera mounted. In this embodiment, three wide-angle cameras are mounted at three angle of the triangle surrounded by the side panels 211, thus there are less obstruction and a wider viewing range. The distance between any two wide-angle cameras in the three wide-angle cameras is equal, so that an included angle between directions of incoming light of any two wide-angle cameras in this embodiment is 120 degrees, thus achieving 360 degree panoramic image acquisition and better meeting recording.

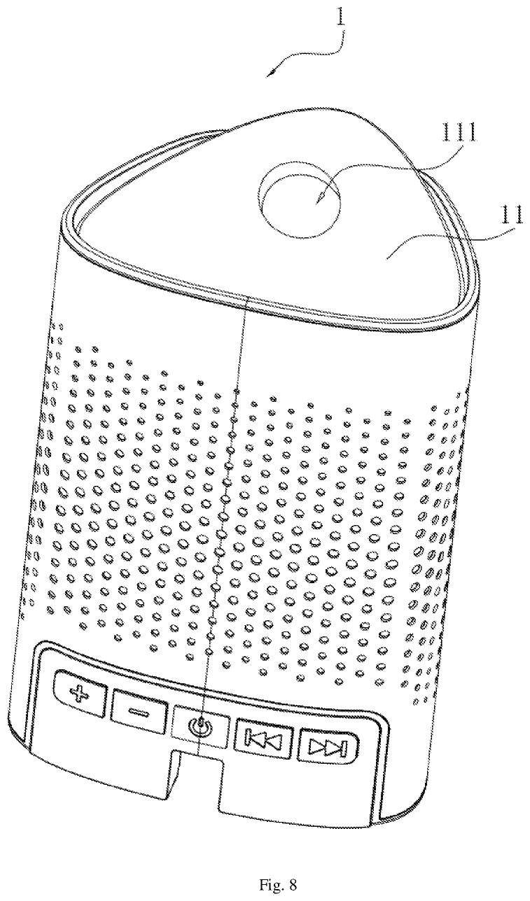

Referring to FIGS. 2 and 8, audio signal can be converted into sound by the speaker box body 1. The speaker box body 1 includes a speaker housing 11 and a speaker assembly 12 mounted inside the speaker housing 11. After the audio signal is amplified by the speaker box body 1, sound is emitted by the speaker box body 1 and the volume of the sound is increased.

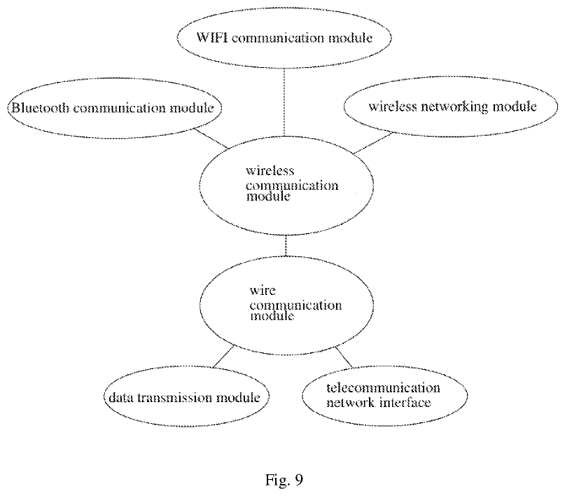

Referring to FIG. 9, further, the speaker assembly 12 includes a wireless communication module and a wire communication module. The wireless communication module may be a Bluetooth communication module, so that the speaker box body 1 has a Bluetooth playing function. The wireless communication module may also be a WIFI communication module or a wireless networking module provided by an supplier to enable different playing mode. In one embodiment, the wireless networking module may be a 2G module. In another embodiment, the wireless networking module may also be an integration of a 4G module and a 5G module, and any combination of one or more modules selected from a group consisting of 2G, 3G, 4G, 5G or 6G modules is within the scope of the present application. The wire communication module may include a telecommunication network interface (also known as a crystal head interface) capable of wired network connection via a connected network wire. The wire communication module can also include data transmission module, such as Micro USB interface, USB Type-C interface or Lighting interface, etc. Smart devices such as mobile phones, tablet PC and computers can be easily connected to the speaker box body 1 through data line, thus realizing the playing of network and local contents. In the present application, when the camera module 2 is used, the speaker box body 1 can play the audio from the camera module 2 linked in preference by software control.

Referring to FIG. 8 again, further, the speaker housing 11 may either be partially or entirely transparent, and the transparent housing may be made of glass, PMMA (polymethyl methacrylate), etc., so that the operation state of the speaker assembly can be easily observed while the speaker assembly is in operation.

Referring to FIG. 3 and FIG. 8, in order to make the camera module 2 more secure and move more stably on the speaker box body 1, a first hole 111 is formed in the speaker housing 11 at the top of the speaker housing 11, and a second hole 201 is formed in the bottom panel 212 of the camera housing 21.

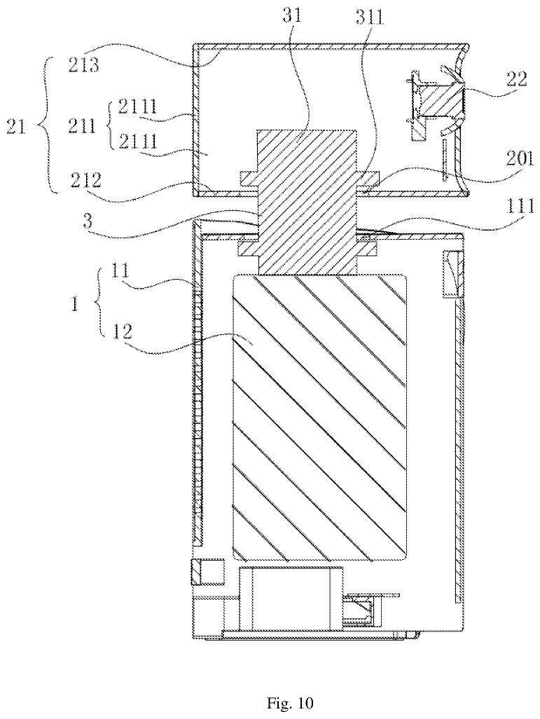

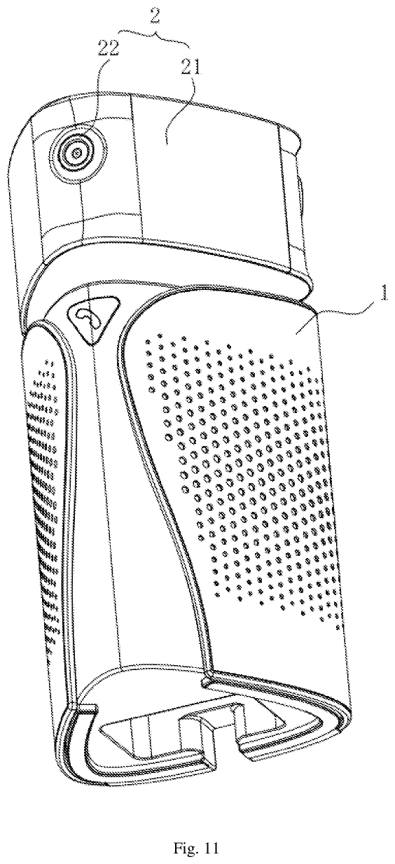

Referring to FIG. 10, in some embodiments, connection assembly 3 may be a connecting rod 31, and the connecting rod 31 is integrally formed with two limit blocks 311, the width of the limit block 311 is greater than the cross-section width of the connecting rod 31. The connecting rod 31 penetrates through the first hole 111 and the second holes 201, so that one of the two limit blocks 311 is stuck inside the speaker housing 11 and the other one of the two limit blocks 311 is stuck inside the camera housing 21, by means of which the camera module 2 and the speaker box body 1 is not easily separated.

Referring to FIG. 2, in another embodiment, the connection assembly 3 includes a rotary drive configured for driving the rotation of the camera module 2. When the speaker box body 1 is placed on a horizontal platform, such as a desk, the camera assembly is able to rotate in a horizontal plane so that the spokesperson's image can be captured within the viewing range.

Referring to FIG. 2, further, the rotary drive is a motor 32, the body of the motor 32 may be mounted in the speaker housing 11, and the output shaft 321 of the motor 32 penetrates through the first hole 111 and the second hole 201, and is fixed to the camera housing 21 by connecting parts, such as bolts, snap-in structures, etc. When the motor 32 is started, the output shaft 321 of the motor 32 rotates synchronously with the camera housing 21. Alternatively, the body of the motor 32 may be mounted in the camera housing 21, and the output shaft 321 of the motor 32 penetrates through the second hole 201 and the first hole 111, and is fixed to the speaker housing 11 by connecting parts. When the motor 32 is started, the body of the motor 32 rotates synchronously with the camera housing 21. This arrangement of the motor 32 increases the weight of the camera module 2, so the camera module 2 is more stable in the process of motion.

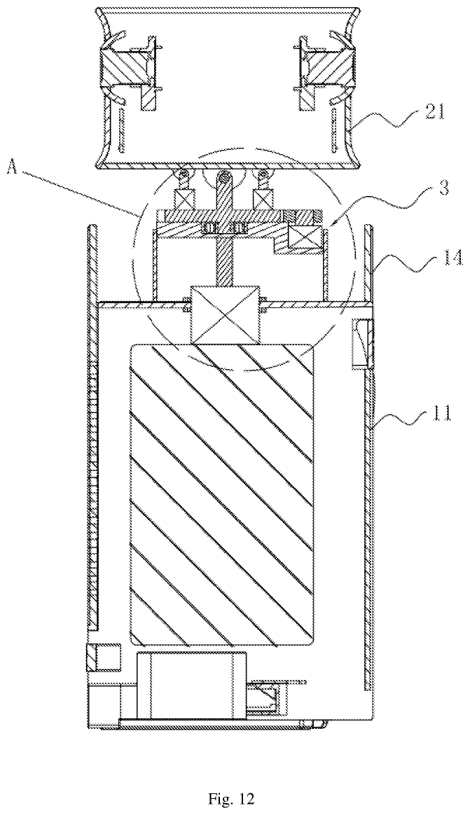

Referring to FIGS. 11 and 12, in another embodiment, the connection assembly 3 is an adjusting drive. The adjusting drive includes a first drive source configured for driving the camera housing 21 up and down, a second drive source configured for driving the camera housing 21 to rotate, and a third drive source configured for adjusting the angle of the incoming light of the camera module 2. A ring-shaped protection sleeve 14 is fixed to the top edge of the speaker housing 11. The camera housing 21 may rotate or slide vertically within the protection sleeve 14 by means of the connection assembly 3, or may perform various operations above simultaneously, thereby allowing more accurate adjustment of the direction of incoming light of the camera module and a wider range of camera modules, which is convenient for focusing on spokespersons of different heights and distances from the camera. To reduce the gap between the protection sleeve 14 and the camera housing 21, the speaker housing 11 and the camera housing 21 may be configured as cylindrical.

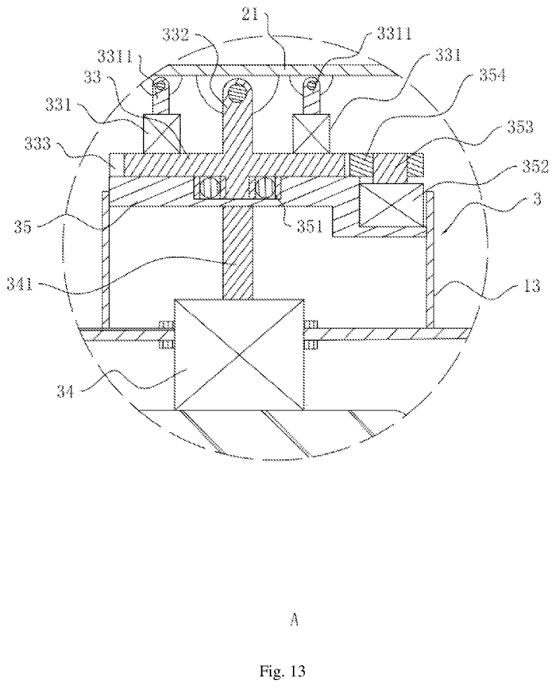

Referring to FIGS. 12 and 13, the connection assembly 3 includes a rotatable plate 33 and a support plate 35 abutted with each other. The rotatable plate 33 and the support plate 35 are connected by a bearing 351, so that the rotatable plate 33 and the support plate 35 can rotate relative to each other. The rotatable plate 33 is a circular plate fixed with a coaxial gear ring 333 fixed on the circumferential side wall. The second drive source is an adjusting motor 352 fixed on the support plate 35. The adjusting motor 352 includes a rotating shaft 353 fixed with a coaxial gear 354. The gear 354 is engaged with the gear ring 333, so that the rotatable plate 33 can be driven to rotate when the adjusting motor 352 is in operation.

The first drive source is a second electric actuator 34 fixed to the speaker housing 11 at the top of the speaker housing 11. The second electric actuator 34 includes a second lifting shaft 341 capable of vertical lifting; an end of the second lifting shaft 341 is fixed to the support plate 35. When the second lifting shaft 341 goes up and down, the support plate 35, the rotatable plate 33 and the camera housing 21 are driven to go up and down, the camera housing 21 can be lifted off the protection sleeve 14 to rotate around a horizontal axis. A guide sleeve 13 is fixed to the speaker housing 11 at the top of the speaker housing 11, and abuts against the side wall of the support plate 35. The guide sleeve 13 is configured to guide the movement of the support plate 35, and protect the connection assembly 3 together with the protection sleeve 14.

Referring to FIGS. 12 and 13, a vertical support strip 332 is fixed on the rotatable plate 33 at the center of the rotatable plate 33 and on the top of the rotatable plate 33, the top end of the support strip 332 is articulated with a bottom panel of the camera housing 21. The third drive source is two first electric actuator 331 fixed on the rotatable plate 33, and a line passing through the two first electric actuator 331 also passes through the axis of the rotatable plate 33. The first electric actuator 331 includes a first lifting shaft 3311 capable of vertical lifting; an end of the first lifting shaft 3311 is articulated with a bottom panel of the camera housing 21. When the first lifting shaft 3311 of one of the two first electric actuator 331 rises, and the first lifting shaft 3311 of the other first electric actuator 331 descends, the camera housing 21 can rotate in a horizontal direction. Correspondingly, two camera assemblies 22 opposite to each other are provided in the camera housing 21, and a line passing through the two camera assemblies 22 is parallel to a line passing through the two first electric actuator 331. So the viewing range of the camera assemblies 22 may be adjusted when the two first electric actuator 331 are in operation.

In another embodiment, more than two camera assemblies 22 can be set within the camera housing 21, and more than two first electric actuator 331 can be set correspondingly, thereby further increasing the camera module's viewing range.

The implementation principle of the camera with a speaker box in the embodiment of the present application is as follows: referring to FIGS. 2 and 11, the camera module 2 is able to rotate relative to the speaker box body 1, the speaker box body 1 not only can act as a speaker box, but also can act as a support of the camera module 2. In a meeting recording, the camera module 2 is able to rotate to capture the current spokesperson; when multiple cameras are included, images of the meeting site may be captured by multiple cameras simultaneously, to reduce image switching and dithering; and when a wide-angle camera is included, a larger viewing range may be obtained with as few cameras as possible.

All the above are preferred embodiments of the present application and not a limit to the scope of the present application. Therefore, any equivalent change in structure, shape and principle of the present application shall falls within the scope of the present application.

What is claimed is:

1. A camera with a speaker box, comprising:
a speaker box body, the speaker box body comprises a speaker housing and a speaker assembly mounted inside the speaker housing, and the speaker assembly is configured for emitting audio; and
a camera module, mounted on the speaker box body via a connection assembly, the camera module comprises a camera housing and a camera assembly mounted in the camera housing and configured to capture an image.

2. The camera with a speaker box according to claim 1, wherein the camera assembly comprises two cameras with different directions of incoming light.

3. The camera with a speaker box according to claim 2, wherein the two cameras are arranged opposite to each other.

4. The camera with a speaker box according to claim 2, wherein an included angle between the directions of the incoming light of the two cameras is from 5 degrees to 150 degrees.

5. The camera with a speaker box according to claim 1, wherein the camera assembly comprises a wide-angle camera.

6. The camera with a speaker box according to claim 1, wherein the camera housing is in any one of a spherical shape, a cylindrical shape, or a frustum shape.

7. The camera with a speaker box according to claim 6, wherein the camera housing comprises at least three vertical panels, the at least three vertical panels are enclosed to form a side panel, and a camera is provided on each of the at least three vertical panels.

8. The camera with a speaker box according to claim 7, wherein the at least three vertical panels are three vertical panels, and an included angle between directions of incoming light of two cameras on adjacent vertical panels of the three vertical panels is 120 degrees.

9. The camera with a speaker box according to claim 1, wherein the camera housing comprises a bottom panel and a side panel, and the bottom panel and the side panel are enclosed to form a cavity for accommodating the camera module.

10. The camera with a speaker box according to claim 9, wherein a top of the camera housing is open.

11. The camera with a speaker box according to claim 10, wherein the side panel is covered with a top panel at a side away from the bottom panel.

12. The camera with a speaker box according to claim 9, wherein the connection assembly comprises a connecting rod, a first hole is formed on speaker housing at a top of the speaker housing for the connecting rod to pass through, a second hole is formed in the bottom panel for the connecting rod to pass through, the connecting rod is connected with two limit blocks, and one of the two limit blocks is stuck inside the speaker housing, and a second one of the two limit blocks is stuck inside the camera housing.

13. The camera with a speaker box according to claim 9, wherein the connection assembly is a motor, the motor comprises an output shaft, a first hole is formed in speaker housing at a top of the speaker housing for the output shaft to pass through, and a second hole is formed in the bottom panel for the output shaft to pass through.

14. The camera with a speaker box according to claim 13, wherein a body of the motor is mounted in the speaker housing, and the output shaft of the motor penetrates through the first hole and the second hole to be fixed to the camera housing, so that the output shaft of the motor moves synchronously with the camera housing.

15. The camera with a speaker box according to claim 13, wherein a body of the motor is mounted in the camera housing, and the output shaft of the motor penetrates through the second hole and the first hole to be fixed to the speaker housing, so that the body of the motor moves synchronously with the camera housing.

16. The camera with a speaker box according to claim 1, wherein the speaker housing and the camera housing contain a transparent housing.

17. The camera with a speaker box according to claim 1, wherein the speaker housing or the camera housing contains a transparent housing.

18. The camera with a speaker box according to claim 1, wherein the speaker assembly comprises a wireless communication module and a wired communication module.

19. The camera with a speaker box according to claim 9, wherein the connection assembly comprises a first drive source configured for driving the camera housing up and down, a second drive source configured for driving the camera housing to rotate around a vertical axis, and a third drive source configured for driving the camera housing to rotate around a horizontal axis.

20. The camera with a speaker box according to claim 9, wherein the connection assembly comprises a rotatable plate and a support plate which are rotatably connected with each other, the rotatable plate is located above the support plate, a first drive source is configured to drive the support plate up and down, a second drive source is provided on the support plate for driving the rotatable plate to rotate, the rotatable plate comprises a support strip hinged with the rotatable plate, and a third drive source is provided on the rotatable plate for driving the camera housing to rotate.
